(19) United States
(12) Patent Application Publication
(10) Pub. No.: US 2014/0327643 A1
(43) Pub. Date: Nov. 6, 2014

(54) DISPLAY PANEL PROTECTION WITH OVERPRESSURE SENSOR ON MOBILE DEVICE

(71) Applicant: NVIDIA CORPORATION, Santa Clara, CA (US)

(72) Inventors: Xiang SUN, Shenzhen (CN); Fei WANG, Guangzhou (CN); Yu ZHAO, Shenzhen (CN)

(73) Assignee: NVIDIA CORPORATION, Santa Clara, CA (US)

(21) Appl. No.: 13/886,124

(22) Filed: May 2, 2013

(51) Int. Cl. G06F 3/041; G06F 3/16

(52) U.S. Cl. CPC G06F 3/0412; G06F 3/16
USPC 345/174; 345/173

(57) ABSTRACT

An overpressure sensing mechanism protecting display panels on mobile computing devices from inadvertent external overpressures. The sensing mechanism comprises a pressure sensor coupled to a display panel and operable to trigger a warning alarm to a user upon detection of an overpressure exerted on the touchscreen. The user receiving the warning alarm may withdraw the overpressure promptly and prevent the display panel from being damaged.

### TECHNICAL FIELD

The present disclosure relates generally to the field of mobile computing devices and more specifically to the field of display panels.

### BACKGROUND

A touchscreen panel, e.g. a display panel, allows a user to interact with an associated computing system by touching the screen with a specified input means. Touchscreen panels have gained increasing popularity in computer systems and particularly in mobile computing devices, such as laptops, PDAs, media players, touchpads, smartphones, etc. To suit consumer's demand for relatively large screen display areas on mobile devices and for convenience, touchscreen display panels are typically designed to occupy a majority portion of an outer surface of the device.

A touchscreen built on various sensing technologies usually comprises a glass substrate that is prone to break when subject to an external overpressure. Due to their relatively small size, they can be easily concealed by other objects and become invisible to and thereby forgotten by a user. A user unaware of its presence may apply an unsafe pressure on the mobile device and thereby damage the functions of the touchscreen display or even break the display. For example, a user may place a smartphone in his or her back pocket and later sit on it before realizing it's present. Or a user may pile a heavy object on the touchscreen inadvertently when the touchscreen is covered by some other object.

### SUMMARY OF THE INVENTION

Therefore, it would be advantageous to provide a mechanism that can protect a display panel of a mobile device from inadvertent overpressure. Embodiments of the present disclosure employ a feedback mechanism having a pressure sensor associated with a touchscreen and operable to trigger a warning alarm to a user upon detection of an external overpressure on the touchscreen. Thereby, a user receiving the feedback or warning signal can advantageously withdraw the imminent overpressure promptly and prevent the touch pad from being damaged.

In one embodiment of the present disclosure, a mobile computing device comprises: a display panel; a component board comprising a bus, a processor and a memory; a pressure sensor coupled to the display panel, control logic coupled to the pressure sensor, an Input/Output (I/O) device coupled to the control logic, and a housing. The pressure sensor is configured to detect an external pressure applied to the display panel and responsive thereto to generate a pressure signal representative of the external pressure. The control logic is configured to compare the pressure signal with a predetermined value and generate an overpressure signal accordingly. The I/O device is operable to generate an indicia indicative of a presence of the overpressure in response to the overpressure signal. The pressure sensor may be a piezoelectric pressure sensor or an optical pressure sensor for instance. The display panel may be a touchscreen. According to various embodiments, the I/O device may be a vibration motor, a flash light, a speaker, or a combination thereof. The indicia may be a vibration, a flashing light, an alarm sound, or a combination thereof, etc.

In another embodiment of the present disclosure, a portable computing device comprises a display panel, a component board, a pressure sensor array coupled with the display panel and arranged in a pattern, control logic coupled to the pressure sensor array, and a housing. The pressure sensor array is configured to detect a compressive pressure imposed on the display panel, and responsive thereto to generate a signal representing an amount of the compressive pressure. The control logic is configured to convert the signal to a digital signal, and generate an alarm signal if the digital signal is greater than or equal to a preset limit or threshold. The portable device may further comprise a vibration motor coupled to the control logic and configured to vibrate continuously in response to the alarm signal.

In another embodiment of the present disclosure, a mobile computing device comprises a touchscreen display, a board, a plurality of pressure sensors, control logic, and a housing. The plurality of pressure sensors are configured to sense a compressive force applied on an outer surface of the touchscreen display, and generate a pressure signal representing the force. The control logic is configured to convert the pressure signal to a digital signal and generate an overpressure signal if the digital signal is greater than or equal to a predetermined limit. The memory is operable to store instructions that implement a graphic user interface (GUI) enabling a user to define an alarm indicia type indicative of detection of an overpressure event. The plurality of sensors may be disposed near edges and a center of the touchscreen display.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1A illustrates an exemplary mobile computing device equipped with a set of pressure sensors (or overpressure sensors) in accordance with an embodiment of the present disclosure.

FIG. 1B illustrates another exemplary mobile computing device equipped with a set of sensors in accordance with an embodiment of the present disclosure.

FIG. 2A illustrates a display panel having a heat-strengthened or fully tempered glass substrate and equipped with a set of overpressure sensors.

FIG. 2B illustrates a flexible display panel having a flexible substrate and equipped with a set of overpressure sensors.

FIG. 3 illustrates an exemplary configuration of overpressure sensing circuits in accordance with an embodiment of the present disclosure.

FIG. 4 is a block diagram illustrating an exemplary configuration of a mobile computing device that comprises an array of overpressure sensors to in accordance with an embodiment of the present disclosure.

FIG. 5 is a flow chart depicting an exemplary method of using the overpressure protection mechanism in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

Display Panel Protection with Overpressure Sensor on Mobile Device

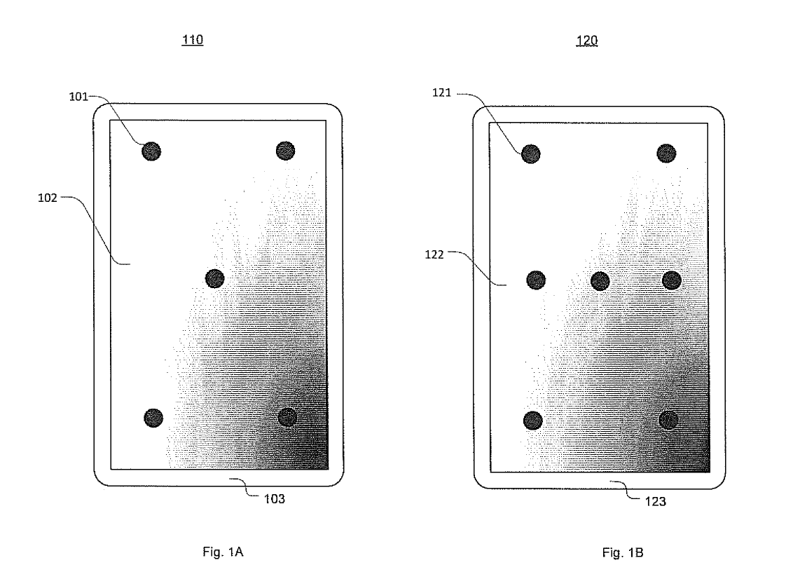

FIG. 1A illustrates an exemplary mobile computing device 110 equipped a set of pressure sensors 101 (or overpressure sensors) in accordance with an embodiment of the present disclosure. The mobile computing device 110 comprises a display panel 102 supported by an exterior housing member 103. In the illustrated embodiment, the display panel 102 may be a touchscreen display having a glass substrate. Five pressure sensors 101 for instance are embedded under the display panel 102 and capable of detecting an external pressure applied on the display panel 102, such as a compressive pressure, and generating pressure signals that represent the amount of the pressure. The mobile device 110 further comprises control logic (not explicitly shown) that, if the amount of pressure exceeds a safe limit, can cause an I/O device to send or render an indicia of the alarm condition to a user. For example, a loudspeaker can be triggered under such circumstances to emit an alarm sound. A user receiving the alarm indicia can be alerted of the existence of unsafe pressure and may promptly withdraw or remove the pressure applied on the display panel. Thereby the display panel is advantageously protected from detrimental effect resulted from the overpressure.

In the embodiment illustrated in FIG. 1A, the five sensors 101 are disposed at the corners and the center of the display panel 102, respectively, such that an overpressure exerted on any location on the display panel can be detected and potentially protected from. However, the present disclosure is not limited to any particular number of sensors or allocation profiles. The number of sensors and their allocation or pattern for a particular mobile device product can be determined by a number of factors, such as the geometry of the display panel 102, material compositions of the display panel 102, the sensitivity of the sensors 101, the response time of the circuits in connected with the sensors, and mechanical strength of other components of the mobile device 110, the intended working environments of the mobile device 110, etc.

FIG. 1B illustrates another exemplary mobile computing device 120 equipped with seven sensors 131 in accordance with an embodiment of the present disclosure in another pattern. In this embodiment, four sensors are placed at the corner and three in the middle of the display panel in light of a comprehensive analysis of the above enumerated factors.

For purposes of practicing this disclosure, the pressures sensors are not limited to any particular type. Any pressure sensors well known in the art can be used in implementation of the overpressure sensing mechanism. For example, the set of sensors may comprise piezoelectric sensors, capacitive sensors, electromagnetic sensors, piezoresistive sensors, optical sensors, potential mechanical sensors, or a combination thereof, etc. Usually the potential damaging forces are dynamic in nature, for instance, a force inadvertently applied by a user or an object held by a user. So it is desirable that the pressure sensing mechanism has a relatively fast response time, including the sensors and the associated circuits.

Some types of sensors, e.g. piezoelectric sensors and potential mechanical sensors, comprises a movable sensing element, (e.g. a diaphragm) and a rigid housing that supports the sensing element. In some embodiments, the movable sensing element of the sensor can be configured to directly contact the display panel while the rigid housing can be fixed with a stationary member of the mobile device, such as a component board, or a housing member of the device.

The overpressure sensing mechanism in accordance with the present disclosure can be used in conjunction with display panels built on various technologies, such as liquid crystal display (LCD) including active or passive matrix LCD, light-emitting diode (LED) including active or passive matrix organic light-emitting diode (OLED), and plasma display panel (PDP). In some embodiments, the pressure sensors can be integrated into an display panel during processing of the display panel.

The display panels can be touchscreens capable of receiving user input by sensing touching pressures. The touchscreen panels used in the present disclosure are not limited to any particular technology and can be, for example, resistive touchscreen panels, surface acoustic wave panels, capacitive touchscreen panels, infrared touchscreen panels, optical touchscreen panels, and so on. Because an input touch pressure is usually well within the safe limit, the sensitivity of the overpressure sensors can be tuned to be beyond the range of a normal input touch pressure such that normal touching operations for input would not be interpreted as overpressure by the overpressure sensing circuitry.

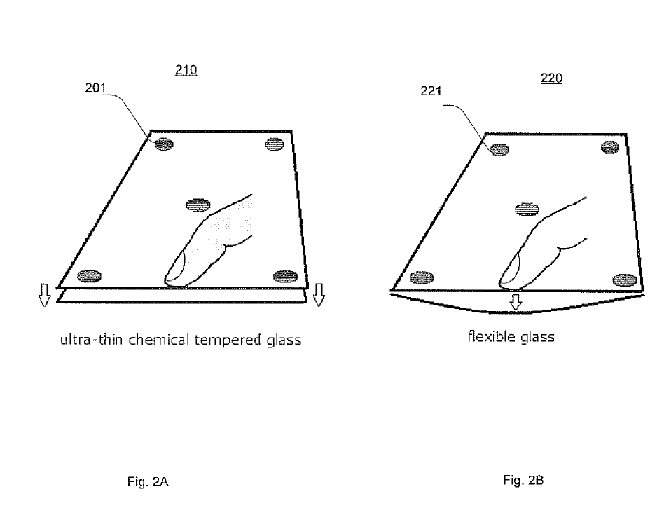

A display panel typically comprises multiple layers made of different materials, including a rigid substrate, e.g. glass. Each constituent layer may have different mechanical strength with respect to a compressive pressure. In some embodiments, to protect a display panel through the overpressure sensing mechanism, the predetermined safe pressure limit can be determined based on a breaking strength of the most fragile layer in the display panel assembly. For instance, a capacitive touchscreen can include four layers, including a top polyester layer, an adhesive spacer, a glass substrate, and an adhesive layer, and the respective coatings on them. Among the several layers, the glass substrate layer is most susceptible to breakage under pressure. Thus, the safe limit can be configured according to a breaking strength of the glass substrate. For instance, FIG. 2A illustrates a display panel 210 having a heat-strengthened or fully tempered glass substrate and equipped with a set of overpressure sensors 201. The exceptional mechanical strength of the glass substrate can account for high safe pressure limit as configured in the overpressure mechanism. In some other embodiments, the safe pressure limit is determined by a comprehensive mechanical strength of the display panel assembly. In some embodiments, the safe pressure limit may be set to a value that is significantly lower than the breaking pressure of the display panel to give user more response time to withdraw the external pressure.

In some embodiments, the overpressure sensing mechanism can be used to protect flexible display panels that comprise flexible substrates, such as plastic films, flexible glass, or metal backplanes. FIG. 2B illustrates a flexible display panel 220 having a flexible substrate 203 and equipped with a set of overpressure sensors 201. Flexible display panels can withstand higher compressive force impact owing to their greater elasticity. However, such display panels are still subject to curvature limitation and may be damaged if an external force deforms the display panel to a point where the curvature limitation is approached or exceeded. Thus the overpressure mechanism can be used to protect flexible display panels from being damaged as well. In addition, a mobile device installed with a flexible display panel may comprise other relatively fragile components, for example a component board, that are prone to breaking when subject to excessive pressure, which can be protected from by using overpressure sensing mechanism.

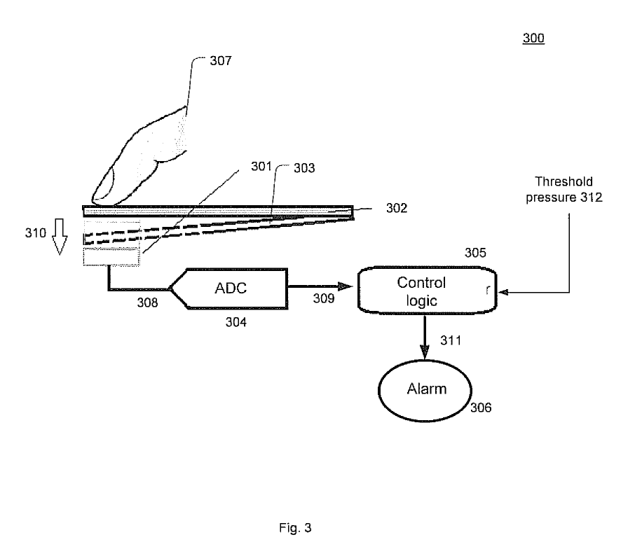

FIG. 3 illustrates an exemplary configuration of overpressure sensing circuits in accordance with an embodiment of the present disclosure. The overpressure sensing circuits comprise a piezoelectric pressure sensor 301, an analog/digital converter (ADC) 304, control logic 305 that is coupled with an alarm device 306. When an external pressure 310, as represented by the arrow, is exerted on a location on the display panel 302, for example by a user 307, the pressure sensor can detect the pressure and generate a pressure signal 308, which is usually an analog signal.

FIG. 3 shows that the compressive pressure 307 causes a downward deformation of the display panel from the original location 302 to a lower location 303, which causes mechanical deformation and displacement of charges in the piezoelectric sensor 301. The outer surfaces of the sensor 301 are thereby charged under pressure 307 which generates an analog signal 308. The analog signal is then converted to a digital signal 309 through the ADC 304. The digital signal 309 is provided to the control logic 305. The control logic can compare the digital signal 309 with a predetermined value 312 that represents a safe pressure limit, and thereby determine whether the pressure 310 constitutes an overpressure, or unsafe pressure. If it is determined that the pressure 310 is unsafe, the control logic instantly sends an overpressure signal 311 to the alarm device 306. In response, alarm device 306 can send off an alarm to a user alarming him or her of the presence of overpressure.

Although the illustrated example shows the center of the external force is directly above the pressure sensor 301, the sensor is capable of detecting an external force located anywhere on the mobile device and even remotely from the pressure sensor 301. For example, the source of the pressure, such as a heavy object, may be on the back housing of the mobile device. As discussed above with reference to FIG. 1, the detection range can be a function of several factors related to the device design.

The piezoelectric sensor 301 may comprises a sensing membrane that is in direct contact with the inner surface of the display panel 302. The sensing membrane of the sensor 301 may be made of piezoelectric ceramics (e.g. PZT), single crystal material (e.g. quartz, tourmaline, and gallium phosphate), and etc.

In some embodiments, the ADC 304 may be coupled with a compensation circuit to amplify and/or stabilize the pressure signal 308 to avoid false alarms.

The present disclosure is not limited by any particular type of alarm device or alarming mechanism. The alarm device 306 can be a loudspeaker that is configured to emit alarm sound in response to detection of an overpressure. In some other embodiments, the alarm device can be a vibrator 306 that is configured to vibrate continuously in response to the overpressure signal 311. In some other embodiments, the alarm sound can be a flash light that flashes in response. The alarm device may also comprise the display panel that can display alarming graphics or flashes.

The control logic 305 may be coupled with a processor in the mobile computing device. When receiving the overpressure signal, the processor can execute a set of pre-loaded instructions which generates alarms to users, such as an alarming graphic, a flashing screen, alarming sound, and etc. In addition, a user may also configure the alarm indicia and safe pressure limit through a graphic user interface (GUI).

A display panel in conjunction with an overpressure sensor to detect a presence of an overpressure or imminent overpressure in accordance with the present disclosure can be applied in any type of computing device that employs a display panel, such as a laptop, a cell phone, a personal digital assistance (PDA), a touchpad, a desktop monitor, a game display panel, a TV, a controller panel, and etc.

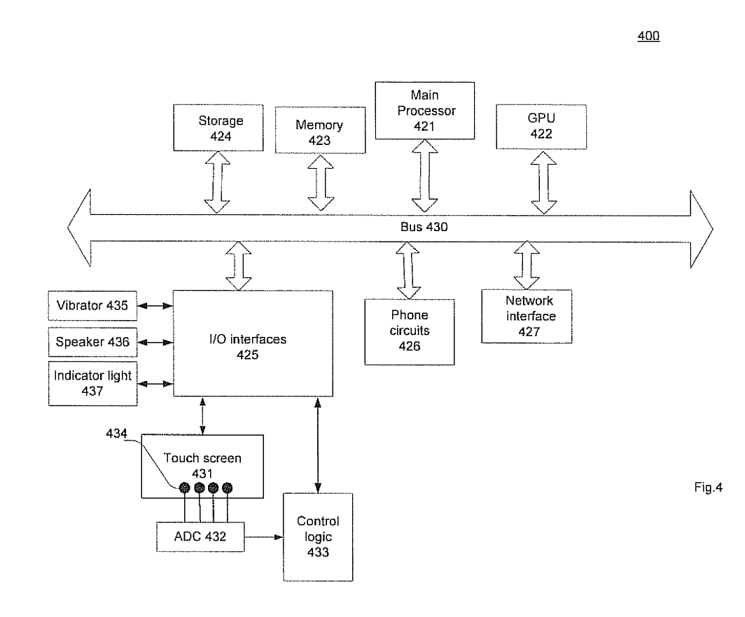

FIG. 4 is a block diagram illustrating an exemplary configuration of a mobile computing device 400 that comprises an array of overpressure sensors 434 to in accordance with an embodiment of the present disclosure. In some embodiments, the mobile computing device 400 can provide computing, communication and/or media play back capability. The mobile computing device 400 can also include other components (not explicitly shown) to provide various enhanced capabilities.

According to the illustrated embodiment in FIG. 4, the computing system 400 comprises a main processor 431, a memory 423, an Graphic Processing Unit (GPU) 422 for processing graphic data, network interface 427, a storage device 424, phone circuits 426, touch screen display panel 433, I/O interfaces 425, and a bus 430, for instance.

The main processor 431 can be implemented as one or more integrated circuits and can control the operation of mobile computing device 400. In some embodiments, the main processor 431 can execute a variety of operating systems and software programs and can maintain multiple concurrently executing programs or processes. The storage device 424 can store user data and application programs to be executed by main processor 431, such as GUI programs, video game programs, personal information data, media play back programs. The storage device 424 can be implemented using disk, flash memory, or any other non-volatile storage medium.

Network or communication interface 427 can provide voice and/or data communication capability for mobile computing devices. In some embodiments, network interface can include radio frequency (RF) transceiver components for accessing wireless voice and/or data networks or other mobile communication technologies, GPS receiver components, or combination thereof. In some embodiments, network interface 427 can provide wired network connectivity instead of or in addition to a wireless interface. Network interface 427 can be implemented using a combination of hardware, e.g. antennas, modulators/demodulators, encoders/decoders, and other analog/digital signal processing circuits, and software components.

I/O interfaces 425 can provide communication and control between the mobile computing device 400 and the touch screen panel 433, the alarm devices including the vibrator 435, the speaker 436, and the indicator light 437, and other external I/O devices (not shown), e.g. a computer, an external speaker dock or media playback station, a digital camera, a separate display device, a card reader, a disc drive, in-car entertainment system, a storage device, user input devices or the like. The sensors 434 are physically connected with the touch screen 431. The sensors 434 are also coupled with an ADC 432 and control logic 433. The control logic 443 may be able to determine whether an external pressure is an overpressure and generate an overpressure signal accordingly. The overpressure signal is then used to one or more I/O device, e.g. 435, 436 and 437, to trigger an alarm indicia. These alarm devices may be dedicated alarm devices but may also be functional devices absent an overpressure situation.

The overpressure signals generated by the control logic 433 may also be communicated to a processor, e.g. the main processor 421 or the GPU 422. The processor can then execute pertinent GUI instructions stored in the memory 423 in response to an overpressure signal. The memory 423 may also store GUI instructions that, when executed by a process, allow a user to change settings of alarm indicia generation, for example increasing the volume of an alarm sound made by the speaker 436 when it receives the overpressure signal.

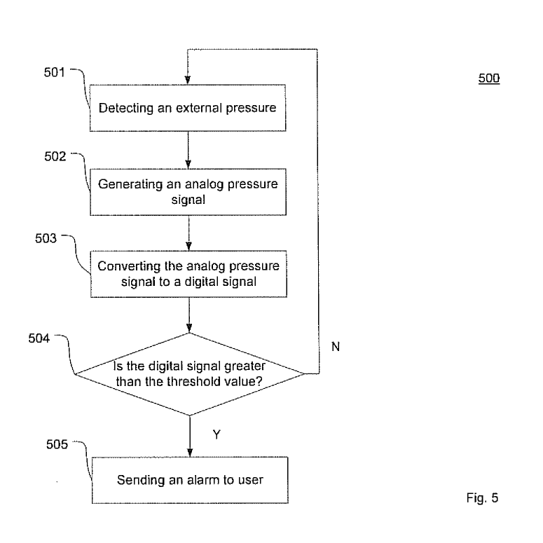

FIG. 5 is a flow chart depicting an exemplary method 500 of using the overpressure protection mechanism in accordance with an embodiment of the present disclosure. The overpressure protection mechanism may be similar with the configuration shown in FIG. 3. At 501, an external pressure applied on the mobile device is detected by the pressure sensors. At 502 the pressure sensors generate a pressure sensor that represents the amount of the external pressure which is then converted to a digital signal at 503. The digital signal is then compared with a threshold value that represents an upper limit of a safe pressure. If it is determined that the external pressure is unsafe at 504, an alarm is sent to a user at 505 to warn him or her to withdraw or remove the external pressure.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A mobile computing device comprising:
a display panel;
a bus; a processor coupled to said bus; and a memory coupled to said processor;
a pressure sensor coupled to said display panel and configured to:
detect an external pressure applied to said display panel; and
generate a pressure signal representative of said external pressure;
control logic coupled to said pressure sensor and configured to:
compare said pressure signal with a predetermined value; and
generate an overpressure signal if said pressure signal is greater than said predetermined value; and
an Input/Output (I/O) device coupled to said control logic and configured to generate an indicia indicative of a presence of said external pressure responsive to said overpressure signal.

2. The mobile computing device as described in claim 1, wherein said display panel is a touchscreen display panel comprising a glass substrate and a flat panel display assembly, and wherein further said pressure sensor is disposed under, and near a center of, said flat panel display assembly.

3. The mobile computing device as described in claim 2, wherein said predetermined value is determined based on a predetermined strength limit of said glass substrate.

4. The mobile computing device as described in claim 2 further comprising a component board comprising said bus, said processor and said memory, and wherein said display panel is a flexible touchscreen panel, and wherein further said predetermined value is determined based on a strength limit of said component board.

5. The mobile computing device as described in claim 1, wherein the pressure sensor comprises a piezoelectric component operable to generate an electrical signal upon application of said external pressure thereto.

6. The mobile computing device as described in claim 1, wherein said pressure sensor comprises an optical pressure sensor operable to detect said external pressure by detecting a compressive deformation of said display panel.

7. The mobile computing device as described in claim 1, wherein said pressure sensor is integrated with said display panel.

8. The mobile computing device as described in claim 1, wherein said pressure sensor comprises a plurality of pressure sensors coupled to said control logic and distributed across a surface of said display panel according to a pattern.

9. The mobile computing device as described in claim 1 further comprising a housing and wherein said pressure sensor comprises a first end and a second end, wherein said first end is attached to said display panel, and wherein said second end is attached to a component of said mobile computing device selected from a group consisting of a Printed Circuit Board (PCB), a battery, and a member of said housing.

10. The mobile computing device as described in claim 1, wherein said I/O device is selected from a group consisting of: a vibration motor; a flash light; a speaker; and a combination thereof, and wherein said indicia is selected from a group consisting of: a vibration; a flashing light; an alarm sound; and a combination thereof.

11. A portable computing device comprising
a display panel;
a logic board coupled to said display panel and comprising: a bus; a processor coupled to said bus; and a memory coupled to said processor;
a pressure sensor array coupled with said display panel and arranged in a pattern, said pressure sensor array configured to:
detect a compressive pressure imposed on said display panel; and
generate a signal representing an amount of said compressive pressure;
control logic coupled to said pressure sensor array and configured to:
convert said signal to a digital signal;
generate an alarm signal if said digital signal is greater than or equal to a preset limit; and
a housing for containing said component board, said pressure sensor array and said display panel.

12. The portable computing device as described in claim 11 further comprising a vibration motor coupled to said control logic and configured to vibrate responsive to said alarm signal.

14. The portable computing device as described in claim 11, wherein said display panel comprises an Active-Matrix Organic Light-Emitting Diode (AMOLED) panel, and wherein further said preset limit is related to a compressive strength of said AMOLED panel.

15. The portable computing device as described in claim 11, wherein said pressure sensor array comprises a plurality of pressure sensors that are distributed across said display panel according to a pattern.

16. The portable computing device as described in claim 11, wherein said pressure sensor array comprises a plurality of piezoelectric sensors.

17. A mobile computing device comprising
a touchscreen display;
a bus; a processor coupled to said bus; and a memory coupled to said processor, wherein said memory is operable to store instructions that, when executed, implement a Graphic User Interface (GUI) enabling a user to define an alarm indicia type indicative of detection of an overpressure event;
a plurality of pressure sensors coupled to said touchscreen display and arranged in a pattern, said a plurality of pressure sensors configured to:
sense a compressive force applied on a outer surface of said touchscreen display; and
generate a pressure signal representing said compressive force; and
control logic coupled to said plurality of pressure sensors and configured to generate an overpressure signal if said pressure signal is exceeds a predetermined limit.

18. The mobile computing device as described in claim 17 further comprising a a housing for containing said touchscreen display, said plurality of pressure sensors, and said control logic, loudspeaker coupled with said control logic, wherein said loudspeaker is configured to receive said overpressure signal and emit alarm sound in response to said overpressure signal when defined as an alarm indicia type via said GUI.

19. The mobile computing device as described in claim 17, wherein said plurality of pressure sensors comprises: a first set of pressure sensors disposed near edges of said touchscreen display; and a second set of pressure sensors disposed near a center of said touchscreen display.

20. The mobile computing device as described in claim 17, wherein said plurality of pressure sensors comprises a plurality of capacitive pressure sensors.
